(19) United States
(12) Patent Application Publication
(10) Pub. No.: US 2011/0281142 A1
(43) Pub. Date: Nov. 17, 2011

(54) LITHIUM-ION POWER BATTERY

(75) Inventors: XIANG-MING HE, Beijing (CN); JIAN-JUN LI, Beijing (CN); JIAN GAO, Beijing (CN); WEI-HUA PU, Beijing (CN)

(73) Assignees: HON HAI PRECISION INDUSTRY CO., LTD., Tu-Cheng (TW); TSINGHUA UNIVERSITY, Beijing (CN)

(21) Appl. No.: 12/981,531

(22) Filed: Dec. 30, 2010

(30) Foreign Application Priority Data
May 12, 2010 (CN) 201010170996.2

(51) Int. Cl. H01M 4/24; H01M 10/02; H01M 10/42

(52) U.S. Cl. 429/7; 429/209; 429/152

(57) ABSTRACT

The present disclosure relates to a lithium-ion power battery. The lithium-ion power battery has a power density greater than or equal to 500 W/kg and includes at least one battery unit including a positive electrode and a negative electrode, a separator, an electrolyte solution, and an external encapsulating shell. The separator is sandwiched between the positive electrode and the negative electrode, and the electrolyte solution is filled between the positive electrode and the negative electrode. The positive electrode, the negative electrode, the separator, and the electrolyte solution are encapsulated in the external encapsulating shell. The positive electrode defines a plurality of first through-holes. The negative electrode defines a plurality of second through-holes corresponding to the first through-holes.

### CROSS-REFERENCE TO RELATED APPLICATIONS

This application claims all benefits accruing under 35 U.S.C. §119 from China Patent Application No. 201010170996.2, filed on May 12, 2010, in the China Intellectual Property Office, the disclosure of which is incorporated herein by reference. This application is related to commonly-assigned applications entitled, “LITHIUM-ION BATTERY AND METHOD FOR MAKING THE SAME,” filed **** (Atty. Docket No. US33317); “LITHIUM-ION POWER BATTERY,” filed **** (Atty. Docket No. US33618); and “LITHIUM-ION BATTERY PACK,” filed **** (Atty. Docket No. US33619).

### BACKGROUND

1. Technical Field

The present disclosure relates to a lithium-ion power battery.

2. Description of Related Art

A common lithium-ion power battery can be a winding type or a stacked type, and includes an encapsulating shell, a positive electrode, a negative electrode, a separator, and an electrolyte solution. The positive electrode, negative electrode, separator, and electrolyte solution are accommodated in the encapsulating shell. The separator is disposed between the positive electrode and the negative electrode. The electrolyte solution sufficiently infiltrates the positive electrode, the negative electrode, and the separator. The positive electrode includes a positive current collector and a positive material layer disposed on the positive current collector. The negative electrode includes a negative current collector and a negative material layer disposed on the negative collector.

The stacked type lithium-ion power battery can include a plurality of positive electrodes and negative electrodes, and the positive electrodes and the negative electrodes can be alternately stacked to form a multilayered structure. The adjacent positive electrode and the negative electrode are spaced by the separator. The multilayered structure can be compactly pressed together to decrease a thickness of the lithium-ion power battery. Consequently, it is difficult to fill the interstices between the positive electrodes and the negative electrodes with the electrolyte solution. The larger the area of the positive electrodes and the negative electrodes, the higher the number of the stacked layers, and the more difficult it is to fill the electrolyte solution. A long period of time is often needed to allow the electrolyte solution to sufficiently infiltrate into the interstices between the positive electrodes and the negative electrodes. For example, the lithium-ion power battery stands for more than ten hours after the electrolyte solution is filled into the shell. Thus, the production efficiency of the lithium-ion power battery is low. In addition, gas produced during charging and discharging of the lithium-ion power battery is difficult to expel out of the lithium-ion power battery because of the compactly stacked structure of the positive electrodes and the negative electrodes, thereby decreasing the recycling properties of the lithium-ion power battery.

What is needed, therefore, is to provide a lithium-ion power battery that will overcome the above listed limitations.

### BRIEF DESCRIPTION OF THE DRAWINGS

Many aspects of the present disclosure can be better understood with reference to the following drawings. The components in the drawings are not necessarily to scale, the emphasis instead being placed upon clearly illustrating the principles of the present embodiments. Moreover, in the drawings, like reference numerals designate corresponding parts throughout the several views.

FIG. 1 is an external schematic view of an embodiment of a battery unit in a lithium-ion power battery.

FIG. 2 is an internal schematic view of the battery unit of FIG. 1.

FIG. 3 is a cross-sectional view along line III-III of the FIG. 2.

FIG. 4 is an assembly schematic view between the trough-hole of positive electrode and negative electrode of the circled portion IV of FIG. 3.

FIG. 5 is a block schematic view of a protective circuit plate of the lithium-ion power battery.

### DETAILED DESCRIPTION

The disclosure is illustrated by way of example and not by way of limitation in the figures of the accompanying drawings in which like references indicate similar elements. It should be noted that references to “another,” “an,” or “one” embodiment in this disclosure are not necessarily to the same embodiment, and such references mean at least one.

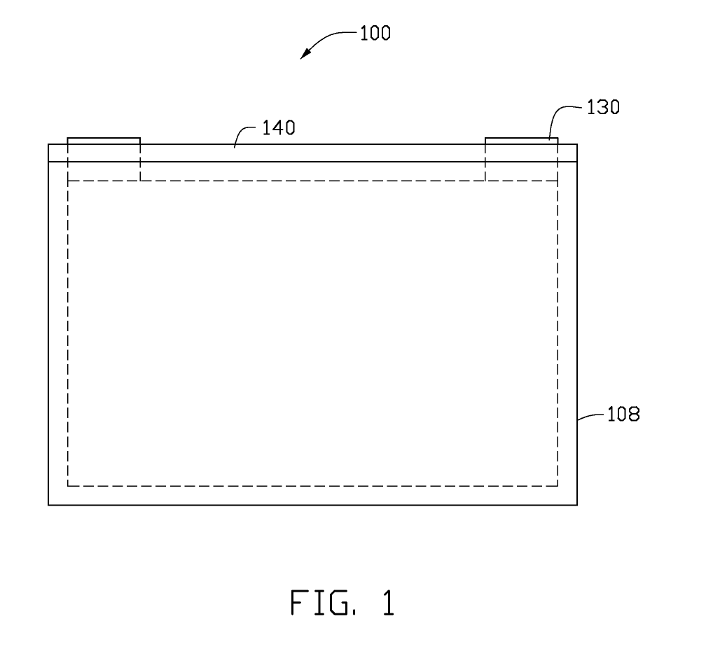

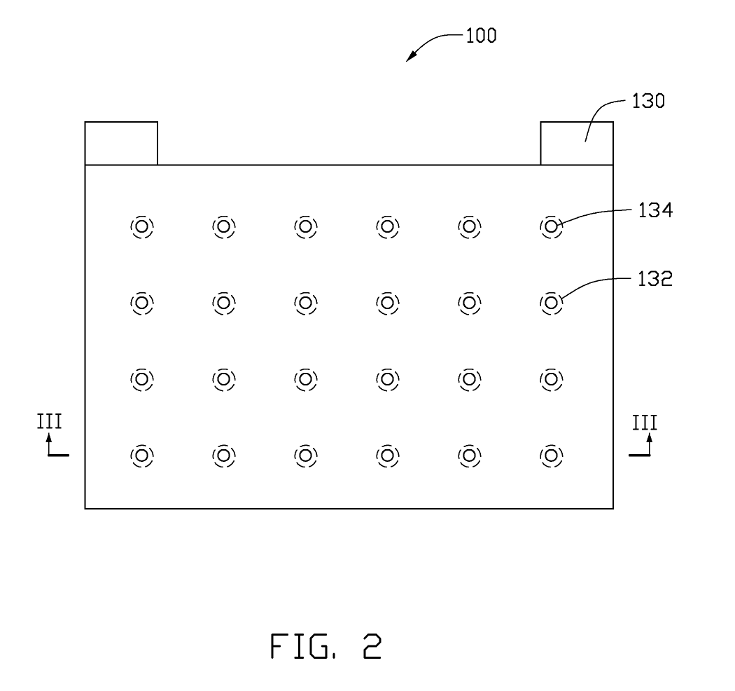

Referring to FIGS. 1 to 4, shows an embodiment of a lithium-ion power battery 100, which has a power density greater than or equal to 500 watts per kilogram (W/kg). The lithium-ion power battery 100 includes at least one battery unit. The battery unit includes at least one positive electrode 102, at least one negative electrode 104, at least one separator 106, a nonaqueous electrolyte solution, and an external encapsulating shell 108. The positive electrode 102, negative electrode 104, separator 106, and nonaqueous electrolyte solution are encapsulated in the encapsulating shell 108. The positive electrode 102 and the negative electrode 104 are stacked with each other and sandwiches the separator 106. The positive electrode 102 and the negative electrode 104 can be in contact with the separator 106. In one embodiment, the positive electrode 102 and the negative electrode 104 are parallel to each other. Furthermore, the battery unit can include a plurality of positive electrodes 102 and a plurality of negative electrodes 104. The positive electrodes 102 and the negative electrodes 104 are alternately stacked with each other. The adjacent positive electrode 102 and the negative electrode 104 are spaced from each other by the separator 106. The number of the positive electrodes 102 and the negative electrodes 104 are not limited. For example, the battery unit can include 1 to 100 layers or more of the positive electrodes 102 and the same number of layers of the negative electrodes 104. In one embodiment, the battery unit includes 20 to 50 layers of the positive electrodes 102 and the same number of layers of negative electrodes 104. In addition, a capacity of the lithium-ion power battery 100 can be larger than or equal to about 10 ampere-hours (Ah).

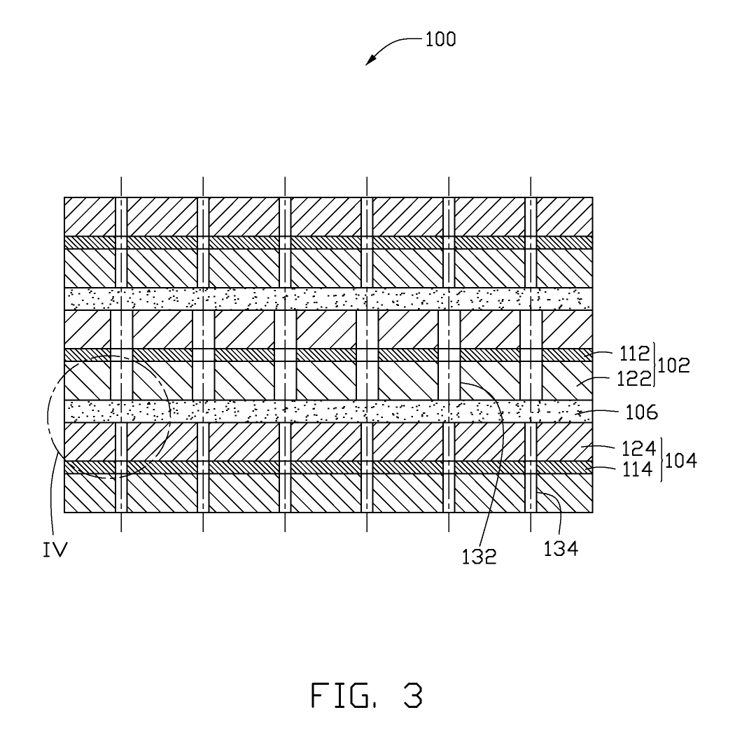

Referring to FIG. 3, each of the positive electrodes 102 includes a positive current collector 112 and at least one positive material layer 122 disposed on at least one surface of the positive current collector 112. Each of the negative electrodes 104 includes a negative current collector 114 and at least one negative material layer 124 disposed on at least one surface of the negative current collector 114. The positive material layer 122 and the negative material layer 124 face each other and sandwiches the separator 106 therebetween. The positive current collector 112 and the negative current collector 114 are sheet shaped. In one embodiment, each of the positive electrodes 102 includes two positive material layers 122 disposed on two opposite surfaces of the positive current collector 112, and each of the negative electrodes 104 includes two negative material layers 124 disposed on two opposite surfaces of the negative current collector 114. If the positive electrodes 102 and the negative electrodes 104 are stacked with each other, the adjacent positive material layer 122 and negative material layer 124 are spaced from each other by the separator 106, and attached to the separator 106.

Furthermore, each of the positive current collector 112 and the negative current collector 114 has a terminal tab 130. The terminal tab 130 of the positive current collector 112 protrudes from the positive material layer 122, and the terminal tab 130 of the negative current collector 114 protrudes from the negative material layer 124. The terminal tab 130 of the positive current collector 112 and the terminal tab 130 of the negative current collector 114 are separated from each other. The terminal tabs 130 are used to electrically connect the positive current collector 112 and the negative current collector 114 with the external circuit. If the battery unit includes the plurality of positive electrodes 102 and the plurality of negative electrodes 104 alternately stacked with each other, the terminal tabs 130 of the plurality of positive current collectors 112 are overlapped with each other, and the terminal tabs 130 of the plurality of negative current collectors 114 are overlapped with each other.

The positive electrode 102 defines at least one first through-hole 132 through the positive current collector 112 and the positive material layer 122. The negative electrode 104 defines at least one second through-hole 134 through the negative material layer 124 and the negative current collector 114. Each second through-hole 134 can be in alignment with one corresponding first through-hole 132. The first and second through-holes 132, 134 have a common axis which can be substantially perpendicular to the separator 106. The electrolyte solution is a liquid. The first through-hole 132 and the second through-hole 134 can be used as a passage for the electrolyte solution. Therefore, the electrolyte solution can infiltrate the interstices between the positive electrode 102 and the negative electrode 104 from the first through-hole 132 or the second through-hole 134, and soak the separator 106. In one embodiment, the positive electrode 102 defines a plurality of first through-holes 132 uniformly distributed, and the negative electrode 104 defines a plurality of second through-holes 134 uniformly distributed. The two opposite surfaces of the positive electrode 102 can be intercommunicated by the first through-holes 132. The two opposite surfaces of the negative electrode 104 can be intercommunicated by the second through-holes 134. The number of the first through-holes 132 and the second through-holes 134 relates to the area of the positive electrode 102 and the negative electrode 104. If a side length of the positive electrode 102 and the negative electrode 104 is less than 10 centimeters (cm), only one first through-hole 132 can be defined at a center of the positive electrode 102, and only one second through-hole 134 can be defined at a center of the negative electrode 104. If an area of the positive electrode 102 and the negative electrode 104 is greater than or equal to 100 cm², a plurality of first through-holes 132 can be defined in the positive electrode 102, and a plurality of second through-holes 134 can be defined in the negative electrode 104. The greater the area of the positive electrode 102 and the negative electrode 104, the larger the number of the stacked layers is needed, and the more difficult it is to fill the electrolyte solution using a conventional method. For example, when the side length of the positive electrode 102 or the negative electrode 104 is greater than or equal to about 50 cm, the electrolyte solution is barely filled between the positive electrode 102 and the negative electrode 104. A plurality of first through-holes 132 and a plurality of second through-holes 134 can be respectively defined in the positive electrode 102 and the negative electrode 104, providing a plurality of flow passages for the electrolyte solution. Therefore, the electrolyte solution can be rapidly filled between the positive electrode 102 and the negative electrode 104, rapidly infiltrating the positive electrode 102, the negative electrode 104, and the separator 106. In addition, when the battery unit includes a plurality of positive electrodes 102 and a plurality of negative electrodes 104, each of the second through-holes 134 of each of the negative electrodes 104 is corresponding to one first through-hole 132 of the adjacent positive electrode 102. An axis of each second through-hole 134 is substantially aligned with an axis of each first through-hole 132.

Each of the second through-holes 134 of the negative electrode 104 corresponds to one first through-hole 132 of the positive electrode 102. The number of the first through-holes 132 of the positive electrode 102 can be larger than or equal to the number of the second through-holes 134 of the negative electrode 104. In one embodiment, the number of the first through-holes 132 is equal to that the number of the second through-holes 134. In addition, the separator 106 should not define any hole to avoid a short circuit between the positive electrode 102 and the negative electrode 104.

The shape of the first through-holes 132 and the second-holes 134 are not limited, and can be round, square, rhombic, triangular, or any combination thereof. The shape of the first through-holes 132 can be the same as the shape of the corresponding second-holes 134. For example, if the shape of the first through-holes 132 is round, the shape of the second through-holes 134 corresponding to the first through-holes 134 is also round. The area of each of the first through-holes 132 and the second through-holes 134 can be in a range from about 0.001 square millimeters (mm²) to about 13 mm² The side length or diameter of each of the first through-holes 132 and the second through-holes 134 can be in a range from about 50 micrometers (μm) to about 4 mm. In one embodiment, the first through-holes 132 and the second through-holes 134 are round in shape having a diameter in a range from about 1 mm to about 2 mm. A distance between the axes of the adjacent first through-holes 132 of the same positive electrode 102 is in a range from about 1 cm to about 50 cm. A distance between the axes of the adjacent second through-holes 134 of the same negative electrode 104 is in a range from about 1 cm to about 50 cm. In one embodiment, the distance is about 5 cm. The plurality of first through-holes 132 defined by the same positive electrode 102 can be arranged in rows to form an array, or arranged radially around the center of the positive electrode 102. The plurality of second through-holes 134 defined by the same negative electrode 104 can be arranged in rows to form an array, or arranged radially around the center of the negative electrode 104. An opening ratio of the through-holes is a ratio of the total area of the through-holes in a surface to the total area of the surface. Each of the opening ration of the first through-hole 132 of the positive electrode 102 and the opening ratio of the second through-hole 134 of the negative electrode 104 can be less than 10%, in one embodiment, less than 2% (e.g. in a range from about 1% to about 2%).

The smaller the opening ratio, the more active material the positive current collector 112 and the negative current collector 114 can carry, thereby avoiding a capacity loss of the lithium-ion power battery 100. Further, the small opening ratio can provide enough strength to the positive current collector 112 and the negative current collector 114.

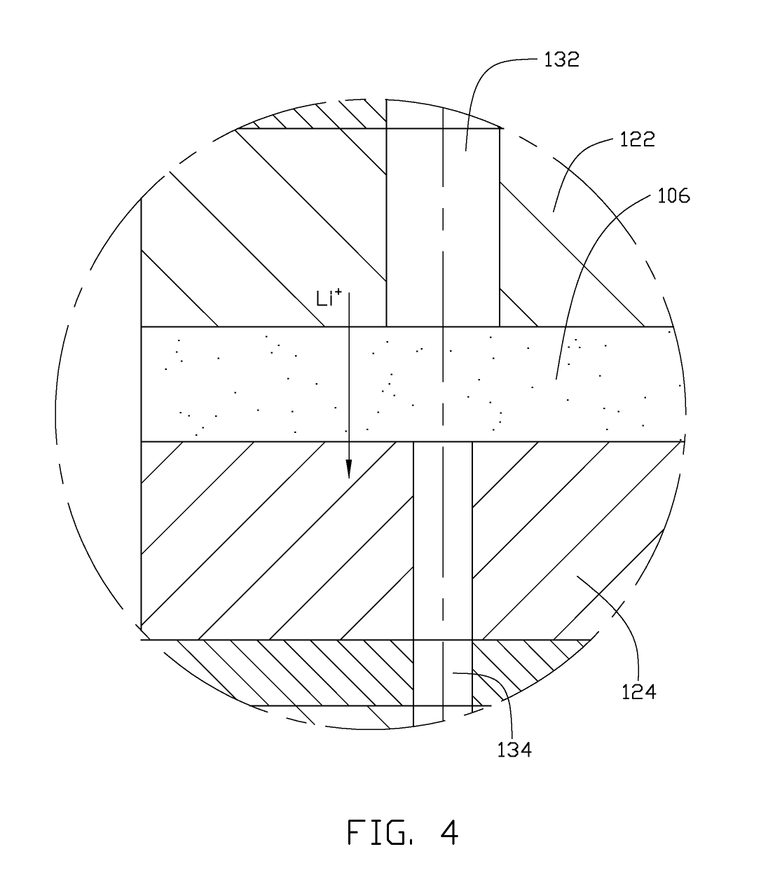

Referring to FIG. 4, a size of the first through-hole 132 of the positive electrode 102 can be larger than or equal to a size of the second through-hole 134 of the negative electrode 104. If the first through-hole 132 and the second through-hole 134 are round in shape, the diameter of the first through-hole 132 can be larger than or equal to the diameter of the second through-hole 134. If the first through-hole 132 and the second through-hole 134 are square in shape, the side length of the first through-hole 132 can be larger than or equal to the side length of the second through-hole 134. In one embodiment, the size of the first through-hole 132 is larger than that of the second through-hole 134 to retain a fitting allowance for assembling the positive electrode 102 and the negative electrode 104 together. If the axis of the first through-hole 132 and the axis of a corresponding second through-hole 134 are not exactly coaxial, the first through-hole 132 can still encompass the second through-hole 134 from a view at a direction substantially perpendicular to the axes of the positive electrode 102 and the negative electrode 104. Namely, a projection of the second through-hole 134 is located in a projection of the first through-hole 132, along a direction substantially perpendicular to the negative electrode 104. Thus, the entire positive material layer 122 of the positive electrode 102 totally falls in the negative material layer 124 of the negative electrode 104 along the direction substantially perpendicular to the negative electrode 104, thereby avoiding a precipitation of the lithium atoms from the positive material layer 122, and improving the safety of the lithium-ion power battery 100. The side length or diameter of the first through-holes 132 can be in a range from about one and a half to about twice of the side length or diameter of the second through-holes 134. In one embodiment, the side length or diameter of the first through-holes 132 is about 2 mm, and the side length or diameter of the second through-holes 134 is about 1 mm. If the battery unit includes a plurality of positive electrodes 102 and a plurality of negative electrodes 104 stacked with each other, the axes of the first through-holes 132 of the plurality of positive electrodes 102 can be aligned with the axes of the corresponding second through-holes 134 of the plurality of negative electrodes 104, or the first through-holes 132 of the plurality of positive electrodes 102 can cover the second through-holes 134 of the plurality of positive electrodes 104 along a direction substantially perpendicular to the positive electrodes 102 and the negative electrodes 104.

The positive current collector 112 and the negative current collector 114 can be made of metal foil. In some embodiments, the positive current collector 112 can be titanium foil or aluminum foil. The negative current collector 114 can be copper foil or nickel foil. A thickness of each of the positive current collector 112 and the negative current collector 114 can be in a range from about 1 μm to about 200 μm. The positive material layer 122 includes a mixture containing positive active material, conductive agent, and adhesive uniformly mixed together. The negative material layer 124 includes a mixture containing negative active material, conductive agent, and adhesive uniformly mixed together. The positive active material can be lithium manganate (LiMn₂O₄), lithium cobalt oxide (LiCoO₂), lithium nickel oxide (LiNiO₂), or lithium iron phosphate (LiFePO₄). The negative active material can be natural graphite, pyrolysis carbon, or mesocarbon microbeads (MCMB). The conductive agent can be acetylene black or carbon fiber. The adhesive can be polyvinylidene fluoride (PVDF) or polytetrafluoroethylene (PTFE). A thickness of the positive electrode 102 can be in a range from about 50 μm to about 300 μm, and a thickness of the negative electrode 104 can be in a range from about 30 μam to about 200 μm. In one embodiment, the thickness of the positive electrode 102 is in a range from about 60 μm to about 150 μm, and the thickness of the negative electrode 104 is in a range from about 50 μm to about 150 μm.

The separator 106 can be a polypropylene microporous film. The electrolyte solution includes an electrolyte and an organic solvent. The electrolyte can be lithium hexafluorophosphate (LiPF₆), lithium terafluoroborate (LiBF₄), lithium bis(oxalato)borate (LiBOB), or combinations thereof. The organic solvent can be ethylene carbonate (EC), diethyl carbonate (DEC), dimethyl carbonate (DMC), ethylmethyl carbonate (EMC), propylene carbonate (PC), or combinations thereof. In addition, the electrolyte solution can be substituted with solid electrolyte film or ionic liquid. If the electrolyte solution is substituted with solid electrolyte film, the separator 106 is also substituted with the solid electrolyte film disposed between the positive material layer 122 and the negative material layer 124.

The external encapsulating shell 108 can be a rigid battery shell or a soft encapsulating bag. The terminal tabs 130 are exposed to outside of the external encapsulating shell 108, thereby connecting the external circuit.

Furthermore, the lithium-ion power battery 100 can include a plurality of battery units connected in series or in parallel. When the plurality of battery units are connected in series, the terminal tab 130 of the positive current collector 112 of one battery unit is electrically connected with the terminal tab 130 of the negative current collector 114 of another battery unit. A rated voltage of the lithium-ion power battery 100, composed of a plurality of the same battery units connected in series, is an integral multiple of a rated voltage of one battery unit. A rated capacity of the lithium-ion power battery 100, composed of a plurality of the same battery units connected in series, is equal to a rated capacity of one battery unit. When the plurality of battery units are connected in parallel, the terminal tabs 130 of the positive current collectors 112 of the plurality of battery units are electrically connected, and the terminal tabs 130 of the negative current collectors 114 of the plurality of battery units are electrically connected. The rated voltage of the lithium-ion power battery 100, composed of a plurality of the same battery units connected in parallel, is equal to the rated voltage of one battery unit. The rated capacity of the lithium-ion power battery 100, composed of a plurality of the same battery units connected in parallel, is an integral multiple of the rated capacity of one battery unit. For example, the positive active material of the battery unit is lithium cobalt oxide, the rated capacity of one battery unit is about 4 Ah, and the rated capacity of five battery units connected in parallel is about 20 Ah.

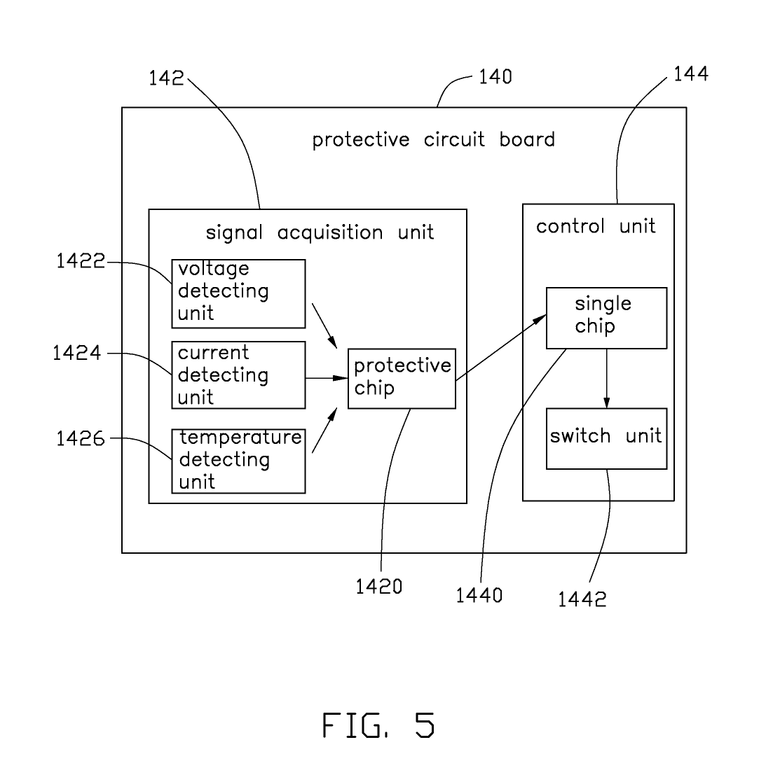

Referring to FIG. 5, the battery unit further includes a protective circuit board 140 electrically connected with the terminal tab 130 of the positive current collector 112 and the terminal tab 130 of the negative current collector 114. The protective circuit board 140 includes a signal acquisition unit 142 and a control unit 144. The signal acquisition unit 142 includes a protective chip 1420, a voltage detecting unit 1422, a current detecting unit 1424, and a temperature detecting unit 1426. The control unit 144 includes a single chip 1440 and a switch unit 1442.

The voltage detecting unit 1422 is electrically connected with the positive electrode 102 and the negative electrode 104. The protective chip 1420 is electrically connected with the voltage detecting unit 1422, and detects the voltage of the battery unit with the voltage detecting unit 1422. The single chip 1440 is electrically connected with the protective chip 1420, and reads the voltage detected by the protective chip 1420. In addition, the single chip 1440 can be used to compare the detected voltage with a set range of voltage, thereby controlling the switch unit 1442 to turn off or connect the charging circuit or discharging circuit of the battery unit. In this embodiment, when the detected voltage value is beyond the pre-set voltage range, the single chip 1440 controls the switch unit 1442 to turn off the charging circuit or the discharging circuit. When the detected voltage is in the pre-set voltage range, the single chip 1440 controls the switch unit 1442 to connect the charging circuit or the discharging circuit. The pre-set voltage range includes an over charging voltage range and an over discharging voltage range.

The current detecting unit 1424 is electrically connected with the positive electrode 102, the negative electrode 104, and the protective chip 1420. The protective chip 1420 can detect the current of the battery unit with the current detecting unit 1424. The single chip 1440 can read the current detected by the protective chip 1420, and compares the detected current with a set range of current, thereby controlling the switch unit 1442 to turn off or connect the charging circuit or discharging circuit of the battery unit. In this embodiment, when the detected current is out of the set current range, the single chip 1440 controls the switch unit 1442 to turn off the charging circuit or the discharging circuit. When the detected current is in the set voltage range, the single chip 1440 controls the switch unit 1442 to connect the charging circuit or the discharging circuit. The set current range includes an overcurrent range and a range of short circuits.

The temperature detecting unit 1426 is electrically connected with the positive electrode 102, the negative electrode 104, and the protective chip 1420. The protective chip 1420 can detect an operating temperature of the battery unit with the temperature detecting unit 1426. The single chip 1440 reads the detected temperature value, and controls the switch unit 1442 to turn off or connect the charging circuit or discharging circuit of the battery unit, according to the detected temperature value.

The protective circuit board 140 lengthens the recycling life or the charging and discharging efficiency of the lithium-ion power battery 100 avoiding the damage caused by over charging or over discharging. The protective circuit board 140 also limits the attenuation of the capacity of the lithium-ion power battery 100 due to overheating. If the lithium-ion power battery 100 includes a plurality of battery units, the protective circuit board 140 can protect each of the battery units, thereby lengthening the service life of the entire lithium-ion power battery 100 and avoiding the damage caused by overcharging and over discharging.

A method for making the lithium-ion power battery 100 includes the following steps:

S1, providing a positive current collector 112 and a negative current collector 114;

S2, coating a positive material layer 122 on the positive current collector 112 to form a positive electrode 102, and coating a negative material layer 124 on the negative current collector 114 to form a negative electrode 104;

S3, defining at least one first through-hole 132 in the positive electrode 102, and at least one second through-hole 134 in the negative electrode 104, wherein a position of the first through-hole 132 corresponds to a position of the second through-hole 134; and

S4, encapsulating the positive electrode 102 and the negative electrode 104 in the external encapsulating shell 108.

In the step S2, the positive material layer 122 and the negative material layer 124 can be fabricated by the following sub-steps: S21, mixing the positive active material, the conductive agent, and the adhesive solution together, thereby forming a positive slurry, and mixing the negative active material, the conductive agent, and the adhesive solution together, thereby forming a negative slurry; S22, coating the positive slurry on the positive current collector 112 using a coating machine, drying the positive slurry thereby forming the positive material layer 122 on the positive current collector 112, coating the negative slurry on the negative current collector 114 using the coating machine, and drying the negative slurry thereby forming the negative material layer 124 on the negative current collector 114. Furthermore, in step S22, the positive material layer 122 and the negative material layer 124 can be compactly pressed together using a laminator.

In step S3, the first through-hole 132 and the second through-hole 134 can be formed by punching, impact molding, or laser etching. The laser etching can form a small size of the first through-hole 132 and the second through-hole 134. The first through-hole 132 is formed after coating the positive material layer 122 to avoid being blocked by the positive slurry. The second through-hole 134 is formed after the coating of the negative material layer 124 to avoid being blocked by the negative slurry. The first through-hole 132 and the second through-hole 134 can be a one to one correspondence. Specifically, the size of the positive electrode 102 is the same as the size of the negative electrode 104, and the positive electrode 102 and the negative electrode 104 can be located together by a locating device. The first through-hole 132 and the second through-hole 134 are simultaneously formed.

If the lithium-ion power battery 100 includes the electrolyte solution or ionic liquid, the above step S4 further includes the following sub-steps of:

S41, providing the separator 106, and disposing the separator 106 between the positive electrode 102 and the negative electrode 104, thereby forming a laminate structure;

S42, pressing the laminate structure using a laminator;

S43, filling the electrolyte solution or the ionic liquid between the positive electrode 102 and the negative electrode 104 from the first through-hole 132 or the second through-hole 134.

In step S41, the separator 106 can be first disposed on a surface of the positive electrode 102, and the negative electrode 104 is then disposed on the separator 106. In the assembling process, the first through-hole 132 of the positive electrode 102 is aligned with the second through-hole 134 of the negative electrode 104. In addition, the lithium-ion power battery 100 can include a plurality of the laminate structures overlapping each other.

In step S43, the first through-hole 132 and the second through-hole 134 can form a flowing passage for the electrolyte solution or the ionic liquid. Therefore, the electrolyte solution or the ionic liquid can flow rapidly between the positive electrode 102 and the negative electrode 104, thereby rapidly infiltrating the positive electrode 102, the negative electrode 104, and the separator 106, and improving the production efficiency of the lithium-ion power battery 100. The larger the area of the positive electrode 102 and the negative electrode 104, the more obvious the effect of the first through-holes 132 and the second through-holes 134. The area of the positive electrode 102 and the negative electrode 104 can be larger than 400 cm². If the positive electrode 102 and the negative electrode 104 are square, the side length of the positive electrode 102 and the negative electrode 104 can be larger than 10 cm. In one embodiment, the side length of the positive electrode 102 and the negative electrode 104 is in a range from about 20 cm to about 100 cm.

If the solid electrolyte is substituted with electrolyte solution or the ionic liquid, the solid electrolyte can be used as the separator 103 disposed between the positive electrode 102 and the negative electrode 104.

Furthermore, a protective circuit board 140 can be provided, to be electrically connected with the positive electrode 102 and the negative 104 after or before the above step S4.

In use, a gas generated by the electrolyte or other element can be easily expelled out of the first through-hole 102 and the second through-hole 104.

Depending on the embodiment, certain steps of the methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A lithium-ion power battery having a power density greater than or equal to 500 W/kg and comprising at least one battery unit comprising a positive electrode and a negative electrode stacked with each other, wherein the positive electrode defines a plurality of first through-holes, the negative electrode defines a plurality of second through-holes, and each of the plurality of the second through-holes corresponds to one of the plurality of first through-holes.

2. The lithium-ion power battery as claimed in claim 1, wherein an area of each of the positive electrode and the negative electrode is larger than or equal to 100 cm².

3. The lithium-ion power battery as claimed in claim 1, wherein a projection of each of the plurality of second through-holes along a direction substantially perpendicular to the negative electrode is located in a projection of a corresponding first through-hole along a direction substantially perpendicular to the negative electrode.

4. The lithium-ion power battery as claimed in claim 3, wherein an axis of each of the plurality of second through-holes is substantially aligned with an axis of a corresponding first through-hole.

5. The lithium-ion power battery as claimed in claim 4, wherein a distance between the axes of adjacent first through-holes and a distance between the axes of adjacent second through-holes are both in a range from about 1 cm to about 50 cm.

6. The lithium-ion power battery as claimed in claim 1, wherein an area of each of the plurality of first through-holes and the plurality of second through-holes is in a range from about 0.001 mm² to about 13 mm².

7. The lithium-ion power battery as claimed in claim 1, wherein an area of each of the plurality of first through-holes is larger than or equal to an area of a corresponding second through-hole.

8. The lithium-ion power battery as claimed in claim 1, wherein an opening ratio of the positive electrode or the negative electrode is less than 10%.

9. The lithium-ion power battery as claimed in claim 1, further comprising a separator, electrolyte solution or ionic liquid, and an external encapsulating shell, wherein the separator is disposed between the positive electrode and the negative electrode, and the positive electrode, the negative electrode, the separator, and the electrolyte solution or ionic liquid are encapsulated in the external encapsulating shell.

10. The lithium-ion power battery as claimed in claim 1, wherein the at least one battery unit comprises a plurality of battery units electrically connected in series.

11. The lithium-ion power battery as claimed in claim 1, wherein the at least one battery unit comprises a plurality of battery units electrically connected in parallel.

12. The lithium-ion power battery as claimed in claim 1, wherein the at least one battery unit further comprises a protective circuit board connected with the positive electrode and the negative electrode, the protective circuit board comprising a signal acquisition unit and a control unit.

13. The lithium-ion power battery as claimed in claim 1, wherein the positive electrode comprises a positive current collector and at least one positive material layer disposed on at least one surface of the positive current collector, and the negative electrode comprises a negative current collector and at least one negative material layer disposed on at least one surface of the negative current collector.

14. The lithium-ion power battery as claimed in claim 13, wherein the at least one positive material layer comprises a mixture comprising positive active material, conductive agent, and adhesive, and the at least one negative material layer comprises a mixture comprising negative active material, conductive agent, and adhesive.

15. The lithium-ion power battery as claimed in claim 1, wherein a shape of the plurality of first through-holes is the same as a shape of the plurality of second through-holes.

16. The lithium-ion power battery as claimed in claim 15, wherein the shape of the plurality of first through-holes and the plurality of second-holes are round, square, rhombic, or triangular.

17. A lithium-ion power battery having a power density greater than or equal to 500 W/kg and comprising at least one battery unit comprising a plurality of positive electrodes and a plurality of negative electrodes alternately stacked with and spaced from each other, each of the plurality of positive electrodes defines a plurality of first through-holes, and each of the plurality of negative electrodes defines a plurality of second through-holes corresponding to the plurality of first through-holes.

18. The lithium-ion power battery as claimed in claim 17, wherein each of the first through-holes has an axis in alignment with that of a corresponding second through-hole.
